(19) United States
(12) Patent Application Publication
(10) Pub. No.: US 2009/0153673 A1
(43) Pub. Date: Jun. 18, 2009

(54) Method and apparatus for accuracy measuring of 3D graphical model using images

(75) Inventors: Chang Woo Chu, Daejeon (KR); Seong Jae Lim, Daejeon (KR); Ho Won Kim, Daejeon (KR); Jeung Chul Park, Daejeon (KR); Ji Young Park, Daejeon (KR); Bon Ki Koo, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/314,855

(22) Filed: Dec. 17, 2008

(30) Foreign Application Priority Data
Dec. 17, 2007 (KR) 10-2007-0132545

(51) Int. Cl. H04N 5/225; G06T 17/00

(52) U.S. Cl. 348/207.1; 345/420; 348/E05.024

(57) ABSTRACT

Disclosed is a technology for measuring a degree of accuracy of a 3D graphical model by using images. The technology includes creating camera parameters by calculating a position, a direction, and intrinsic parameters of a camera through a calibration of the camera to a reference image which is photographed for reference during creation of the 3D graphical model of an actually existing object; calculating a position and a direction of the 3D graphical model based on a corresponding relation between the reference image and 3D graphical model data obtained by digitizing the actually existing object; creating a synthesized image by rendering the 3D graphical model using the camera parameters; extracting characteristics of the reference image and the synthesized image; and calculating distance and length errors based on a corresponding relation between the extracted characteristics of the two images.

### CROSS-REFERENCE TO RELATED APPLICATIONS

The present invention claims priority of Korean Patent Application No. 10-2007-0132545, filed on Dec. 17, 2007 which is incorporated herein by reference.

### FIELD OF THE INVENTION

The present invention relates to a technology for digitizing an actually existing object as a 3D graphical model; and, more particularly, to a method and an apparatus for measuring the accuracy of a 3D graphical model reconstructed with an actually existing model by calibrating a camera to a reference image photographed for reference, to calculate the position, direction, and intrinsic parameters of the camera that photographed the reference image, extracting the characteristics of an image reconstructed by projecting the created model and the photographed image, comparing the characteristics to measure an error, and displaying a portion of the 3D model that is to be corrected to notice to a designer.

### BACKGROUND OF THE INVENTION

In general, in order to create a 3D graphical model using an actual object, a skilled designer repeats correction of a 3D model until the 3D model becomes similar to the actual object referring to the image photographed directly. In a traditional 3D graphical model creating method, determination of the accuracy of a created 3D model depends only on subjective determination of a designer based on the vision of the designer. In particular, if a 3D graphical model is rendered to a 2D image, geometrical inaccuracy of the model can be visually reduced in some degree using texture mapping or other high quality rendering functions. However, such a 3D model cannot be used in an application requiring accuracy.

In order to overcome the above-mentioned shortcomings, a 3D scanner is being used to create an accurate model and thereby improve convenience of use. A model created using a 3D scanner has been known to be more accurate than any other possible 3D model. However, the range of a model that can be created using a 3D scanner is limited, and such a model includes too many polygons to be used in applications such as animation, visual effects, computer games, and virtual reality. A technology such as decimation that is studied in the field of computer graphics may be used to reduce the number of polygons to an applicable level.

However, in the method for creating a 3D graphical model using a 3D scanner, an actual object may be relatively accurately modeled but is limited generally to a static object. Further, a face of a human being that is one of main objects of a 3D model causes much noise in a scanned 3D image itself and a face of the same person creates a different shape according to its photographed time point, deteriorating the reliability of the scanned 3D image itself. Furthermore, the purpose of modeling a face is mainly animation of the face in which its shape varies, but the 3D scanning technology cannot make the best use of the characteristics of animation.

Therefore, a 3D scanning result is used only for reference, but actually, a 3D model is still manually created by a designer. As a result, the accuracy of a 3D graphical model may not be secured even when a 3D scanner is used.

### SUMMARY OF THE INVENTION

It is, therefore, a primary object of the present invention to provide a method and an apparatus for measuring the accuracy of a 3D graphical model using an image adapted to visually inform a designer of the accuracy of the 3D graphical model and a portion having errors in the 3D graphical model by comparing a reference image obtained by photographing an actual object and a created 3D model.

It is another object of the present invention to provide a method and an apparatus for measuring the accuracy of a 3D graphical model that enables measurement of the accuracy of a 3D graphical model obtained by recreating an actually existing object, by calibrating a camera to a reference image photographed for reference calculating the position, direction, and intrinsic parameters of the camera that photographed the reference image, extracting the characteristics of an image created by projecting the created model and the photographed image, comparing the characteristics to measure an error, and displaying a portion of the 3D model that is to be corrected to a designer.

In accordance with one aspect of the present invention, there is provided a method for measuring a degree of accuracy of a 3D graphical model including creating a camera parameter by calculating a position, a direction, and intrinsic parameters of a camera through a calibration of the camera to a reference image which is photographed for reference during creation of the 3D graphical model of an actually existing object; calculating a position and a direction of the 3D graphical model based on a corresponding relation between the reference image and 3D graphical model data obtained by digitizing the actually existing object;

creating a synthesized image by rendering the 3D graphical model using the camera parameter; extracting characteristics of the reference image and the synthesized image; and calculating distance and length errors based on a corresponding relation between the extracted characteristics of the two images.

It is preferable that the characteristics of the images are at least one of corner points, lines, and curved lines.

It is preferable that the method further includes dividing ranges of the distance and length errors into a plurality of sections; and displaying the sections of which each section has different color.

It is preferable that the method further includes semi-transparently overlapping the synthesized image on the reference image and displaying the overlapped synthesized image.

In accordance with another aspect of the present invention, there is provided an apparatus for measuring a degree of accuracy of a 3D graphical model including a camera calibrator creating camera parameters by calculating a position, a direction, and intrinsic parameters of a camera from a reference image which is photographed for reference during creation of the 3D model for an actually existing object; a model synthesizer calculating a position and a direction of the 3D graphical model based on a corresponding relation between the reference image and 3D graphical model data obtained by digitizing the actually existing object; a renderer creating a synthesized image by rendering the 3D graphical model using the camera parameters;an image characteristic extractor extracting characteristics of the reference image and the synthesized image; and an error calculator calculating distance and length errors based on corresponding relation between the extracted characteristics of the two images.

It is preferable that the characteristics of the images are at least one of corner points, lines, and curved lines.

It is preferable that the apparatus further includes a display unit dividing ranges of the distance and length errors calculated by the error calculator into a plurality of sections and displaying the section of which each section has different color.

It is preferable that the display unit semi-transparently overlaps the synthesized image on the reference image and displays the overlapped synthesized image.

The main effect of the present invention will be described as follows.

In creating the same 3D graphical model as an actually existing object, the efficiency of a modeling operation increases by visually informing a designer of the accuracy of and an erroneous portion of the 3D graphical model by comparing a reference image obtained by photographing an actual object and a created 3D model.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating an accuracy measuring apparatus for a 3D graphical model according to an embodiment of the present invention;

FIG. 2 is a flowchart illustrating an accuracy measuring procedure for a 3D graphical model according to an embodiment of the present invention;

FIG. 3 is a view illustrating a reference image according to an embodiment of the present invention; and

FIG. 4 is a view illustrating an accuracy measuring result and expressing method thereof according to the embodiment of the present invention.

### DETAILED DESCRIPTION OF THE EMBODIMENTS

Hereinafter, exemplary embodiments of the present invention will be described in detail with reference to the accompanying drawings. Detailed descriptions of well-known functions and structures incorporated herein may be omitted to avoid obscuring the subject matter of the present invention. The terms used herein are those defined in consideration of the functions of the present invention and may be different according to intentions and customs of a user or a manager. Therefore, the definitions of the terms will be fixed on the basis of the entire content of the specification.

The purpose of the present invention is to visually inform a designer of the accuracy of a created 3D model and an error occurring section after comparing a reference image obtained by photographing an actual object with the 3D model.

Therefore, according to the present invention, the position, direction, and intrinsic parameters of a photographing camera are calculated through the calibration of a camera to an image photographed for reference, and the characteristics of the image created by rendering a created model and the photographed image are extracted, and a designer is informed of a section to be corrected by comparing the characteristics of the images and measuring an error.

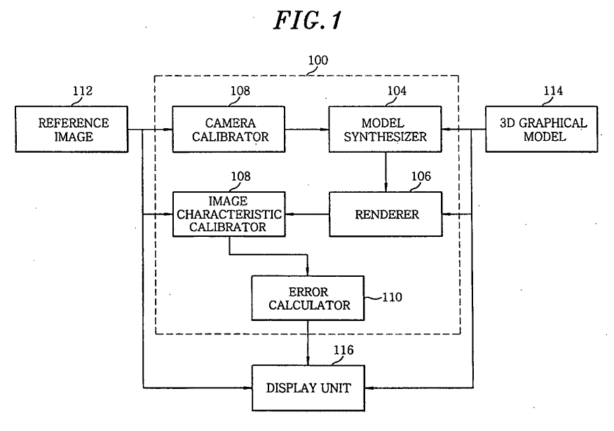

FIG. 1 is a block diagram illustrating an accuracy measuring apparatus for a 3D graphical model according to an embodiment of the present invention.

With reference to FIG. 1, the accuracy measuring apparatus 100 for a 3D graphical model is adapted to measure the accuracy of a 3D model using a reference image 112 and a created 3D graphical model 114, and includes a camera calibrator 102, a model synthesizer 104, a renderer 106, an image characteristic extractor 108, and an error calculator 110.

The reference image 112 is at least one image photographed for reference so that a designer creates a model using it, and may be a plurality of images photographed from various locations and angles. As the number of reference images 112 is larger, the accuracy of the 3D model 114 can be measured in more detail. The 3D graphical model is the one created based on an actual object, and includes both a model manually created by a designer and a model created using equipment such as a 3D scanner.

The camera calibrator 102 of the accuracy measuring apparatus 100 for a 3D graphical model extracts a camera parameters by calculating the position, direction, and intrinsic parameters of the camera that photographed the reference image 112 using the input reference image 112, and extracts the characteristics of the images and sets the correspondence relation between the images. The camera is calibrated based on the set correspondence relation. In calibration of the camera, a camera self-calibration algorithm that is being actively studied in the field of computer vision may be used. A camera may be calibrated in advance by photographing a calibration pattern with the position and direction of the camera being fixed, using a triangular pod.

In this case, the image obtained by photographing the camera calibration pattern may be used as the input image for camera calibration. In the case of there being one reference image 112, when calibration of the camera becomes impossible due to inexistence of the image obtained by photographing a calibration pattern or of a vanishing point of the image, it can be omitted and intrinsic parameters may be assumed to be a general value.

The model synthesizer 104 calculates the position and direction of the 3D graphical model so that, when the 3D graphical model 114 is projected to the reference image 112 with the camera parameters calculated by the camera calibrator 102 and the current 3D graphical model being an input, the 3D model 114 can be projected to an image section of the target object. Then, a user (or designer) may designate the correspondence relation between the image and the 3D graphical model.

The renderer 106 renders the 3D graphical model to an image of the same resolution as that of the reference image 112 using the position and direction of the 3D graphical model 114 and the camera parameters and creates a synthesized image. Then, since the camera matrix of a graphics library, such as OpenGL and Direct3D, mainly used in a personal computer is different from the camera matrix of a computer vision, it is necessary to transform the camera matrix. The renderer 106 stores the synthesized image that has been created by rendering, and the synthesized image is input to the image characteristic extractor 108.

The image characteristic extractor 108 extracts the characteristics of the images with the reference image 112 and the synthesized image created by the renderer 106 being inputs. The characteristics of the images are properly selected from those extractable through image processing, such as corner points, lines, and curved lines, according to the type of the target object. For example, in the case of a building, corner points and lines may be the main characteristics. On the other hand, in the case of a face, curved lines may be the main characteristics.

The error calculator 110 quantitatively calculates the difference between the characteristics of the two images extracted by the image characteristic extractor 108, and sets the correspondence relation between the characteristics extracted from the two images. The basic objective of the present invention is to create the same 3D graphical model as an actually existing object, and the 3D graphical model 300 input to the accuracy measuring apparatus 100 for a 3D graphical model is a model finished in some measure. Further, since the model synthesizer 104 calculates the position and direction of the 3D model, the characteristics extracted from the two images are confirmed at similar locations. Accordingly, the error calculator 110 sets the correspondence relation between the two images and calculates an error such as the distance and length between the characteristics.

The display unit 116 displays the data output through respective blocks of the accuracy measuring apparatus 100 for a 3D graphical model. In other words, the display unit 116 outputs the image rendered using the reference image 112 and the 3D graphical model 114, the camera parameters calculated by the camera calibrator 102, and the position and direction of the 3D model that are calculated by the model synthesizer 104, and the reference image 112. Then, only semi-transparently overlapping the image created by the renderer 106 on the reference image 112 and showing the overlapped image may enable confirmation of the approximate accuracy of the 3D graphical model by naked eyes. Further, overlapping the characteristics extracted by the image characteristic extractor 108 and the error calculated by the error calculator 110 and showing them together may easily inform a user of a section that is to be corrected.

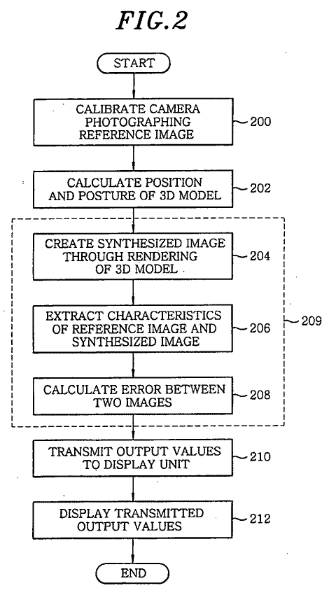

FIG. 2 is a flowchart illustrating an accuracy measuring procedure for a 3D graphical model according to an embodiment of the present invention.

With reference to FIG. 2, camera parameters are created by carrying out calibration of a camera using a reference image 112 input to a camera calibrator 102 and calculating the position, direction, and intrinsic parameters of the camera that photographed the image in step 200, and a model synthesizer 104 calculates the position and direction of a 3D graphical model 114 using the correspondence relation between the reference image 112 and a 3D graphical model 114 designated by a user in step 202. Then, the renderer 106 creates a synthesized image by rendering the 3D graphical model 114 using the camera calibration result and the position and direction of the 3D graphical model 114 in step 204.

An image characteristic extractor 108 extracts the characteristics of the reference image 112 and the synthesized image in step 206 and calculates an error between the two images by setting the correspondence relation between the characteristics extracted from the reference image 112 and the synthesized image.

Steps 204 and 208 are repeated with respect to respective reference images photographed from different positions and directions as in step 209.

The values output in units of blocks in the accuracy measuring apparatus 100 for a 3D graphical model are transmitted to a display unit 116 in step 210, and the display unit 116 displays the transmitted output values. In other words, the display unit 116 visually expresses the reference image, the synthesized image, and the accuracy measuring result of the 3D graphical model.

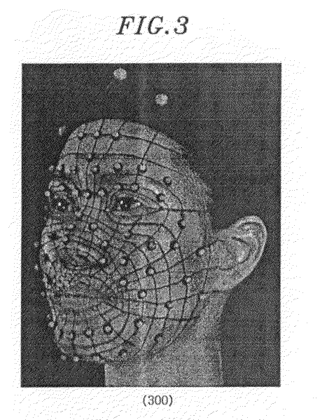

FIG. 3 is a view illustrating a reference image according to an embodiment of the present invention.

FIG. 3 expresses a face portion of a reference image 112. The face portion may lack characteristics as in FIG. 3 and may be made up so that its accuracy may be easily measured.

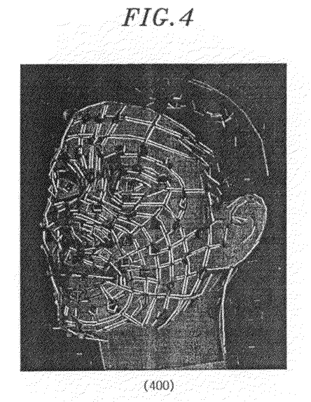

FIG. 4 is a view illustrating an accuracy measuring result and its expressing method according to the embodiment of the present invention

With reference to FIG. 4, an error is obtained by comparing the reference image of FIG. 3 with a 3D face model. In the embodiment of the present invention, an image characteristic extractor 108 extracts an edge and divides the extracted edge into relatively easily treatable lines, and an error calculator 110 calculates the correspondence relation between the characteristics of the images and acquires an error by calculating the distance between corresponding lines. In displaying the accuracy measured result by the display unit 116, an error range is divided into a plurality of sections that are indicated with different colors so that a user can easily recognize the divided error ranges with the colors. For example, when the distance between lines of a section is more than 6 pixels, the section is indicated with a different color such as red. The user confirms the section and corrects an erroneous portion in a 3D graphical model to more accurately create the 3D graphical model.

As mentioned above, an object of the present invention is to visually inform a designer of an accuracy of a 3D graphical model and an erroneous model by comparing a reference image obtained by photographing an actual object and a created 3D model. According to the present invention, a camera is calibrated to a photographed reference image, the position, direction, and intrinsic parameters of the camera are calculated, a created model is projected to extract the characteristics of the created image and the photographed image, an error is measured by comparing the characteristics of the images, and a portion of the 3D model that is to be corrected is displayed.

While the invention has been shown and described with respect to the embodiments, it will be understood by those skilled in the art that various changes and modifications may be made without departing from the scope of the invention as defined in the following claims.

What is claimed is:

1. A method for measuring a degree of accuracy of a 3D graphical model comprising:
creating camera parameters by calculating a position, a direction, and intrinsic parameters of a camera through a calibration of the camera to a reference image which is photographed for reference during creation of the 3D graphical model of an actually existing object;
calculating a position and a direction of the 3D graphical model based on a corresponding relation between the reference image and 3D graphical model data obtained by digitizing the actually existing object;
creating a synthesized image by rendering the 3D graphical model using the camera parameters;
extracting characteristics of the reference image and the synthesized image; and
calculating distance and length errors based on corresponding relation between the extracted characteristics of the two images.

2. The method of claim 1, wherein the characteristics of the images are at least one of corner points, lines, and curved lines.

3. The method of claim 1, further comprising:
dividing ranges of the distance and length errors into a plurality of sections; and
displaying the sections of which each section has different color.

4. The method of claim 1, further comprising semi-transparently overlapping the synthesized image on the reference image and displaying the overlapped synthesized image.

5. An apparatus for measuring a degree of accuracy of a 3D graphical model comprising:
a camera calibrator creating camera parameters by calculating a position, a direction, and intrinsic parameters of a camera from a reference image which is photographed for reference during creation of the 3D graphical model of an actually existing object;
a model synthesizer calculating a position and a direction of the 3D graphical model based on a corresponding relation between the reference image and 3D graphical model data obtained by digitizing the actually existing object;
a renderer creating a synthesized image by rendering the 3D graphical model using the camera parameters;
an image characteristic extractor extracting characteristics of the reference image and the synthesized image; and
an error calculator calculating distance and length errors based on a corresponding relation between the extracted characteristics of the two images.

6. The apparatus of claim 5, wherein the characteristics of the images are at least one of corner points, lines, and curved lines.

7. The apparatus of claim 5, further comprising a display unit dividing ranges of the distance and length errors calculated by the error calculator into a plurality of sections and displaying the section of which each section has different color.

8. The apparatus of claim 7, wherein the display unit semi-transparently overlaps the synthesized image on the reference image and displays the overlapped synthesized image.
